(19) United States
(12) Patent Application Publication
(10) Pub. No.: US 2026/0284625 A1
(43) Pub. Date: Sep. 24, 2026

(54) FLUIDIZED BED REACTOR FOR GAS PHASE POLYMERIZATION OF OLEFINS

(71) Applicant: BASELL POLYOLEFINE GMBH, Wesseling (DE)

(72) Inventors: Giulia Mei, Ferrara (IT); Lorella Marturano, Ferrara (IT); Gabriele Mei, Ferrara (IT); Pietro Baita, Ferrara (IT)

(73) Assignee: BASELL POLYOLEFINE GMBH, Wesseling (DE)

(21) Appl. No.: 19/168,701

(22) PCT Filed: Mar. 28, 2024
(86) PCT No.: PCT/EP2024/058490

§ 371 Date: Sep. 24, 2025

(30) Foreign Application Priority Data
Mar. 30, 2023 (EP) 23165308.0

(51) Int. Cl. B01J 8/18; B01J 8/26; C08F 10/02

(52) U.S. Cl. CPC B01J 8/1827; B01J 8/26; C08F 10/02; B01J 2208/00938; B01J 2208/00991

(57) ABSTRACT

A fluidized bed reactor for gas phase fluidized bed polymerization of olefins, having a first section, which is an upright cylindrical section having an inner diameter D₁, a height H₁ and a cross sectional area A₁; and a frustrum shaped second section, provided vertically above the first section and centered about a common vertical axis to the upright cylindrical first section, having a base with a cylindrical cross section of diameter D₁ joined to the top of the first section and tapering out above the base at an angle. The second section has a maximum horizontal cross-sectional area, which is between 2.95 to 3.2 times the cross-sectional area A₁ of the first section, the height is between 10 to 25 m, and the angle is between 5 to 15°.

### FIELD OF THE DISCLOSURE

In general, the present disclosure relates to the field of chemistry. More specifically, the present disclosure relates to polymer chemistry. In particular, the present disclosure relates to a fluidized bed reactor for gas phase fluidized polymerization of olefins and processes for preparing an olefin polymer in the fluidized bed reactor.

### BACKGROUND OF THE DISCLOSURE

In some instances, gas-phase polymerization processes are used for the polymerization of olefins such as homopolymerizing ethylene or propylene or copolymerizing ethylene or propylene with other olefins. In some instances, gas-phase polymerizations are carried out in fluidized-bed reactors, stirred gas-phase reactors or multizone circulating reactors with two distinct interconnected gas-phase polymerization zones. In some instances, the components in the gas-phase mixture are made from or containing monomers and comonomers, in the presence of a polymerization catalyst system. In some instances, the components in the gas-phase mixture are further made from or containing other gaseous components such as polymerization diluents, molecular weight modifiers, or low-molecular weight reaction products. In some instances, the polymerization diluents are nitrogen or alkanes. In some instances, the molecular weight modifier is hydrogen. In some embodiments, the resulting solid polyolefin particles.

Fluidized-bed reactors are reactors in which the polymerization takes place in a bed of polyolefin particles. In some instances, the bed is maintained in a fluidized state by feeding a reaction gas mixture at the lower end of a reactor and taking off the gas again at the top of the fluidized-bed reactor. In some instances, the reaction gas mixture is fed below a gas distribution grid, which dispenses the gas flow. The reaction gas mixture is then returned to the lower end of the reactor via a recycle line equipped with a centrifugal compressor and a heat exchanger for removing the heat of polymerization. The flow rate of the reaction gas mixture fluidizes the bed of finely divided polymer in the polymerization zone and removes the heat of polymerization. To maintain the fluidized bed at more or less constant volume, polymer product is withdrawn to compensate for the fresh polymer that is generated during the course of polymerization.

In some instances, the fluidized bed reactor is split into two sections, wherein a first section extends towards the lower end and a second section extends from the first section towards an upper end. In some instances, the first section is an upright cylindrical section, wherein the fluidized bed of particles is maintained. In some instances, the second section is connected to the first section at a distal end of the first section, facing away from the lower end. In some instances, the second section has a frustrum shape, tapering out in a direction away from the first section at an angle. It is believed that the increased cross sectional area in the second section reduces the gas velocity such that the fluidizing gas does not entrain the polymer particles. However and in some instances, small particles or fines are entrained with the fluidizing gas. In some instances, the entrained fines cause fouling in the recycle line and the components therein. In some instances, an increase in the cross-section of the second section reduces the fluidizing gas velocity in the second section and causes a drop of the entrained particles, thereby leading to fouling on the inner walls of the fluidized bed reactors.

### SUMMARY OF THE DISCLOSURE

In a general embodiment, the present disclosure provides a fluidized bed reactor for gas phase fluidized bed polymerization of olefins, having
(I) a first section, which is an upright cylindrical section having a diameter D₁, a height H₁ and a cross sectional area A₁; and
(II) a frustrum shaped second section, provided vertically above the first section and centered about a common vertical axis to the upright cylindrical first section,
   (A) having a base with a cylindrical cross section of diameter D₁ joined to the top of the first section and
   (B) tapering out above the base at an angle a,
      wherein
(i) the second section has a maximum horizontal cross-sectional area, which is between 2.95 to 3.2 times the cross sectional area of the first section;
(ii) the height H₁ is between 10 to 25 m; and
(iii) the angle at which the second section tapers out (angle a) is between 5 to 15°.

In some embodiments, the first diameter (D₁) is more than 4.6 m.

In some embodiments, the fluidized bed reactor has a gas distribution grid and a settling pipe, wherein the settling pipe having an upper opening integrated into the gas distribution grid, the gas distribution grid being arranged in the first section and the settling pipe extending out of the first section at the end distal to the second section.

In some embodiments, the settling pipe has a tapered end distal to the gas distribution grid.

In some embodiments, the settling pipe is arranged coaxially to the first section.

In some embodiments, the present disclosure provides a reactor assembly having a series of at least two gas-phase polymerization reactors, wherein at least one of the gas-phase polymerization reactors is a fluidized bed reactor.

In some embodiments, the reactor assembly has two gas-phase polymerization reactors, wherein a first gas-phase polymerization reactor is a fluidized bed reactor and a second gas-phase polymerization reactor is a multizone circulating reactor and arranged downstream of the fluidized bed reactor.

In some embodiments, the present disclosure provides a process for preparing a polyolefin polymer from one or more olefins by gas-phase polymerization at temperatures of from 40 to 150° C. and pressures of from 0.1 to 20 MPa, alternatively from 0.3 MPa to 5 MPa, in presence of a polymerization catalyst, wherein the polymerization is at least partly carried out in a fluidized bed reactor.

In some embodiments, a superficial gas velocity in the second section is lower than 0.30 m/s, alternatively lower than 0.25 m/s. In some embodiments, the superficial gas velocity in the second section higher than 0.05 m/s, alternatively higher than 0.1 m/s.

In some embodiments, a fluidization velocity is lower than 0.75 m/s, alternatively lower than 0.60 m/s. In some embodiments, the fluidization velocity is higher than 0.30 m/s, alternatively higher than 0.40 m/s.

In some embodiments, the polyolefin polymer is a polyethylene prepared by homopolymerizing ethylene or copolymerizing ethylene and C₃-C₈-1 alkenes. In some embodiments, the polyolefin polymer is a polyethylene prepared by homopolymerizing ethylene.

In some embodiments, the polyethylene has a density in the range of from 0.915 g/cm³ to 0.970 g/cm³, alternatively from 0.9600 to 0.9670 g/cm³.

In some embodiments, the polyethylene has a MIE of between 7.5 to 8.5 g/10′ where MIE is the melt flow index at 190° C. based on 2.16 kg load determined according to ISO 1133-2:2011.

In some embodiments, the polyolefin polymer is a monomodal polyolefin polymer.

In some embodiments of the process, the reactor assembly has a series of at least two gas phase polymerization reactors, wherein (i) one of the gas phase polymerization reactors is a fluidized bed reactor, (ii) the polyolefin is prepared in the fluidized bed reactor, and (iii) the polyolefin is not prepared in any of the additional gas phase polymerization reactors.

In some embodiments, the reactor assembly has two gas phase polymerization reactors arranged in series, wherein the first gas-phase polymerization reactor being the fluidized bed reactor and the second gas-phase polymerization reactor being a multizone circulating reactor.

In some embodiments, the first gas-phase polymerization reactor is arranged upstream from the second gas-phase polymerization reactor.

### BRIEF DESCRIPTION OF THE DRAWINGS

FIG. 1 shows a schematic of a fluidized bed reactor.

FIG. 2 shows a schematic of a reactor assembly having a fluidized bed reactor and a multizone circulating reactor.

### DETAILED DESCRIPTION OF THE INVENTION

As used herein, the terms “diameter”, “height” and “cross-sectional area” refer to the inner diameter, inner height and inner cross-sectional area of the corresponding section of the fluidized bed reactor. In some embodiments, the height H₁ refers to the height of the first section. In some embodiments, a distribution grid is installed in the bottom of the first section and the height of the first section corresponds to the height measured from the uppermost part of the distribution grid to the end of the first section (that is, the beginning of the second section).

As used herein, the term “about” refers to and includes a value, irrespective of an explicit mention that that the recited value is included. Thus, the absence of an explicit indication that the term “about” includes a recited value does not exclude the value from the range of variations created by the term “about”. Even in the absence of an explicit indication that the term “about” includes the recited value, the value is included in the range of variations created by the term “about”. In some instances, deviations around a recited value are fractional or integral. In some instances, the deviations are fractional when the value is related to an attribute selected from the group consisting of temperature, pressure, and duration.

As used herein, the term “comprising” refers to “including”, “encompassing”, or “containing”. As used herein, the term “comprising” includes the explicitly recited elements and allows for the presence of other non-recited elements. In some embodiments and as used herein, the term “comprising” may have the limiting meaning “consisting of”. An aspect or embodiment defined as “comprising” certain features, also includes the meaning of “consisting of” those features, whether explicitly stated or not. In some embodiments, the term “comprising” has the meaning “consisting essentially of”.

In some embodiments, an aspect, embodiment or feature of the disclosure is combined with another aspect, embodiment or feature of the disclosure.

In some embodiments, olefins are polymerized in the gas-phase polymerization reactors. In some embodiments, the olefins are 1-olefins. As used herein, the term “1-olefins” refers to hydrocarbons having terminal double bonds, without being restricted thereto. In some embodiments, the olefins are nonpolar olefinic compounds. In some embodiments, the 1-olefins are linear C₂-C₁₂-1-alkenes, branched C₂-C₁₂-1-alkenes, conjugated dienes, or non-conjugated dienes. In some embodiments, the linear alkenes are linear C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are branched C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene and 1,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized.

In some embodiments, the gas phase polymerization reactor is for the homopolymerization or copolymerization of ethylene or propylene, alternatively for the homopolymerization or copolymerization of ethylene. In some embodiments, comonomers in propylene polymerization are up to about 40 wt. %, alternatively about 0.5 wt. % to about 35 wt. %, of ethylene, 1-butene, 1-hexene, or a combination thereof, with respect to the total weight of monomer and comonomers in the final polymer. In some embodiments, comonomers in ethylene polymerization are up to about 20 wt. %, alternatively from about 0.01 wt. % to about 16 wt. %, alternatively from about 0.05 wt. % to about 13 wt. %, of C₃-C₈-1-alkenes, with respect to the total weight of monomer and comonomers in the final polymer. In some embodiments, the alkenes are selected from the group consisting of 1-butene, 1-pentene, 1-hexene, 1-octene, and combinations thereof. In some embodiments, ethylene is copolymerized with from about 0.1 wt. % to about 13 wt. % of 1-hexene, 1-butene, or a combination thereof.

In some embodiments, the present disclosure provides a fluidized bed reactor for a gas phase polymerization of olefins. In some embodiments, the fluidized bed reactor has a first section, which is an upright cylindrical section having a first diameter, a height and a cross sectional area, wherein the first height being between 10 to 25 m. In some embodiments, the fluidized bed reactor has a second section, provided vertically above the first section and centered about a common vertical axis to the upright cylindrical first section. In some embodiments, the base of the second section has a cylindrical cross sectional area of the first diameter and is joined to the top of the first section. In some embodiments, the second section tapers out at an angle between about 5° to about 15°. In some embodiments, the second section is frustrum shaped, wherein the diameter gradually increases from the base in the direction away from the first section until a maximum diameter (that is, a second diameter) is reached. The maximum horizontal cross sectional area of the second section is between about 2.95 to about 3.2 times larger than the first cross sectional area.

In some embodiments, polymerization processes are operated in fluidized bed reactors, wherein the maximum cross sectional area of the second section is about 2.95 to about 3.2, alternatively about 2.98 to about 3.2, alternatively about 2.99 to about 3.2, alternatively about 3.0 to about 3.2, times larger than the first cross sectional area, thereby reducing the entrainment of particles and preventing plugging of the distribution grid, the heat exchanger, or both. When the reduction of the entrainment is not managed (that is, the angle at which the second section tapers out is too large) and as the particles drop in the second section, the particles may adhere to the slanted walls of the second section. Conversely, when the angle at which the second section tapers out is too low, an increase in the height, space and material of the second section are dictated to achieve the maximum cross sectional area. In some embodiments, the angle at which the frustrum shaped second section tapers out (that is, the slant angle) is from 5 to 15°, alternatively from 7 to 13°, alternatively from 9 to 11°, thereby providing a balance between the height of the second section and the slant of the reactor wall for preventing adherence of the particles on the slanted surface.

In some embodiments, the maximum cross sectional area of the second section is from about 2.95 to about 3.2 times, alternatively between 2.95 and 3.2 times, higher than the first cross sectional area. In some embodiments, the maximum cross sectional area of the second section is from about 2.95 to about 3.2, alternatively between 2.95 to 3.2, times larger than the first cross sectional area. Alternatively, the maximum cross sectional area of the second section is from 2.95 to 3.15, alternatively between 2.95 and 3.15, times higher than the first cross sectional area.

In some embodiments, the first height ranges from 8 to 30 m, alternatively from 10 to 25 m, alternatively from 10 to 23 m, alternatively between 8 and 30 m, alternatively between 10 to 25 m, alternatively between 10 to 23 m.

In some embodiments, the first diameter is more than 4.6 m. In some embodiments, a fluidized bed reactor with a large volume is provided, thereby increasing the production capacity of the reactor. In comparison, some other fluidized bed reactors, having a relatively large diameter in the first section (that is, in the fluidization zone), have the drawback that the overall gas throughput results in an increase of particle attrition and fines generation, even if the disengagement zone is increased in proportion to the fluidization zone. In some embodiments, the present fluidized bed reactor has an increased size of the maximum cross sectional area of the second section, thereby reducing the fines carryover and preventing fouling of components. In some embodiments, the components include heat exchangers or the distribution grid.

In some embodiments, the first diameter is more than 4.6 m, alternatively at least 5.0 m. In some embodiments, there is no upper limit for the first diameter. In some embodiments, the first diameter is less than 10.0 m, alternatively less than 7.0 m.

In some embodiments, the first section is cylindrical, alternatively approximately cylindrical. In some embodiments, the horizontal cross sectional area of the first section is calculated as follows:

$${A}_{1} = {π ( \frac{{D}_{1}}{2} )}^{2}$$

In some embodiments, if the first diameter D₁ is more than 4.6 m, the first cross sectional area A₁ is at least 15.9 m².

In some embodiments, the frustrum shaped second section has the shape of a truncated cone, wherein the inner diameter of the cone gradually increases above the second section's base in the direction away from the first section, until the maximum diameter of the second section Dₘₐₓ is reached. In some embodiments, the second section has a circular horizontal cross sectional area, which maximum is calculated by

$${A}_{max} = {π ( \frac{{D}_{max}}{2} )}^{2} .$$

In some embodiments and once the maximum diameter is reached, the second section ends. In some embodiments, an end section continues from the end of the second section. In some embodiments, the end section is a cylindrical part having the maximum diameter of the second section. In some embodiments, the end section is referred to as a third section and closes off the reactor as a spherical dome, either directly at the end of the second section or after an extension.

In some embodiments and to achieve a homogenous distribution of the fluidizing gas in the bed of growing polymer particles, a gas distribution grid, alternatively referred to as gas fluidization grid or distribution plate, is installed in the lower part of the first section. In some embodiments, the gas distribution grids are provided with apertures which dispense into the bed a gas stream introduced under the grid. In some embodiments, the grid also acts as support for the bed when the supply of gas is cut off.

In some embodiments, the distribution grid is integrally built together with the reactor walls. In some embodiments, the distribution grid is a separate part. In some embodiments and as a separate part, the distribution grid is removably or irremovably fixed to the reactor walls.

In some embodiments, the gas distribution grid has a plurality of trays. arranged to form the lateral walls of an inverted cone. In some embodiments, the plurality of trays is attached to each other to form slots in the overlapping area of adjacent trays. In comparison, some other gas distribution grids have the shape of a cylindrical disc, which is perforated by a large number of through-holes for the passage of the fluidizing gas from the zone underlying the grid to the fluidized polymer bed. In some instances and after exceeding a certain size, the distribution of the fluidizing gas through the polymer bed becomes less homogeneous, thereby permitting dense and poorly fluidized regions to appear in the bed. In some instances, the dense and poorly fluidized regions appear in the vicinity of the walls of the apparatus. In some embodiments, the presently-disclosed gas distribution grid provides homogenous distribution of an upward gas flow into the vessel containing a polymer in fluidized conditions, even when the first diameter is large.

As used herein, the term “gas distribution grid” refers to a grid or a plate having the function of dispensing an upward flow of gas for fluidizing a polymer bed, without excluding the optional feed of a liquid together with the gas flow. As used herein, the term “condensing mode” refers a polymerization process operated in the presence of little amounts of liquid monomers in the stream of fluidizing gas.

As used herein, the term “tray” refers to a flat component, like a plate or a sheet. In some embodiments, the tray is deformed at a side, thereby generating one or more slots when overlapped with a successive, adjacent tray.

As used herein the term “overlapping area” refers to an area where a first tray extends upon a second tray, such that both trays can be fixed to each other, thereby forming slots in this overlapping area.

In some embodiments, the trays are built of a material, which resists the temperatures and pressures of the polymerization process. In some embodiments, the material is steel. In some embodiments, the overlapping of successive trays generates annular modules of trays (that is, adjacent trays are mounted to each other, thereby forming a ring structure). In some embodiments, these annular modules are mounted side by side, thereby generating the entire structure of the gas distributor.

In some embodiments, the gas distribution grid has the shape of an inverted cone having an apex of from 100° to 160°, alternatively from 120° to 150°. In some embodiments, the module of trays forms the lateral walls of the inverted cone.

In some embodiments, the fluidized bed reactor has the gas distribution grid mounted in the first section of the fluidized bed reactor and a settling pipe extending out of the reactor volume at the end distal to the second section. In some embodiments, the settling pipe has an upper opening integrated into the gas distribution grid.

In some embodiments, a part of the settling pipe protruding out of the reactor volume is provided with an inlet for introducing a fluid into the settling pipe. In some embodiments, the settling pipe is positioned such that the settling pipe is coaxially arranged to the first section. In some embodiments, the settling pipe is arranged substantially vertically. As used herein, the term “substantially vertically” refers to the angle between the longitudinal direction of the settling pipe and the vertical being not more than 40°, alternatively not more than 10°. In some embodiments, the lower end of the settling pipe tapers conically, thereby preventing a dead zone where polymer particles stuck.

In some embodiments, polyolefin particles, coming from the fluidized bed, fall due to gravity into the settling pipe and form therein a densified bed of polyolefin particles. At the lower end of the settling pipe, polyolefin particles are withdrawn and optionally transferred to a second gas-phase reactor. Consequently, the polyolefin particles within the settling pipe move downwards from top to bottom of the settling pipe under the force of gravity. In some embodiments, the polyolefin particles move as plug flow from top to bottom of the settling pipe.

In some embodiments and at the settling pipe's lower end, a discharge valve is provided for withdrawing the polyolefin particles from the settling pipe. In some embodiments, the discharge valve is a segmental ball valve, ball valve or rotary plug valve. In some embodiments, the discharge valve is a segmental ball valve. In some embodiments and by regulating this valve, the discharge flow is controlled and the bed level inside the fluidized-bed reactor is maintained constant. In some embodiments, the discharge of the polyolefin particles is carried out continuously or intermittently. In some embodiments, the discharge of the polyolefin particles is carried out continuously. In some embodiments, the discharge of the polyolefin particles is carried out intermittently and the opening intervals of the valve are selected such that the continuous polymerization in the fluidized bed reactor is not, or minimally, disturbed.

In some embodiments, the inlet is arranged such that an upward stream of an introduced fluid is induced in the bed of polyolefin particles above the fluid introduction point. In some embodiments, the inlet is configured to introduce the fluid into the lower third of the settling pipe, alternatively at a position near the lower end of the settling pipe. In some embodiments, the fluid is introduced at more than one position into the settling pipe. In some embodiments, the settling pipe has more than one inlet. In some embodiments, a gas distributor is provided, thereby distributing the fluid in a way that over the whole cross-section of the settling pipe in a region above the fluid introduction point. In some embodiments, the fluid is a gas, a liquid which evaporates under the conditions in the settling pipe, or a mixture of a gas and such a liquid. In some embodiments, the fluid is a gas. In some embodiments, the introduced fluid replaces the reaction gas of the fluidized bed reactor and acts as barrier, thereby preventing the reaction gas of the fluidized bed reactor from being discharged and optionally transferred to a second reactor arranged downstream of the fluidized bed reactor. In some embodiments, the fluid is a component of the reaction gas mixtures of the fluidized bed reactor and optionally the subsequent reactor. In some embodiments, the fluid is an inert component, alternatively a saturated hydrocarbon. In some embodiments, the saturated hydrocarbon is propane. In some embodiments, the amount of fluid fed is regulated. In some embodiments, the regulation induces and sustains an upward stream of the fluid in the bed of polyolefin particles above the fluid introduction point. In some embodiments, the amount of fluid is limited, thereby avoiding expansion of the bed in the settling pipe and associated transport of polyolefins back into the fluidized bed reactor. In some embodiments, the amount of fluid is regulated with regard to (a) diluting the reaction gas with the fluid or (b) purging part of the reaction gas.

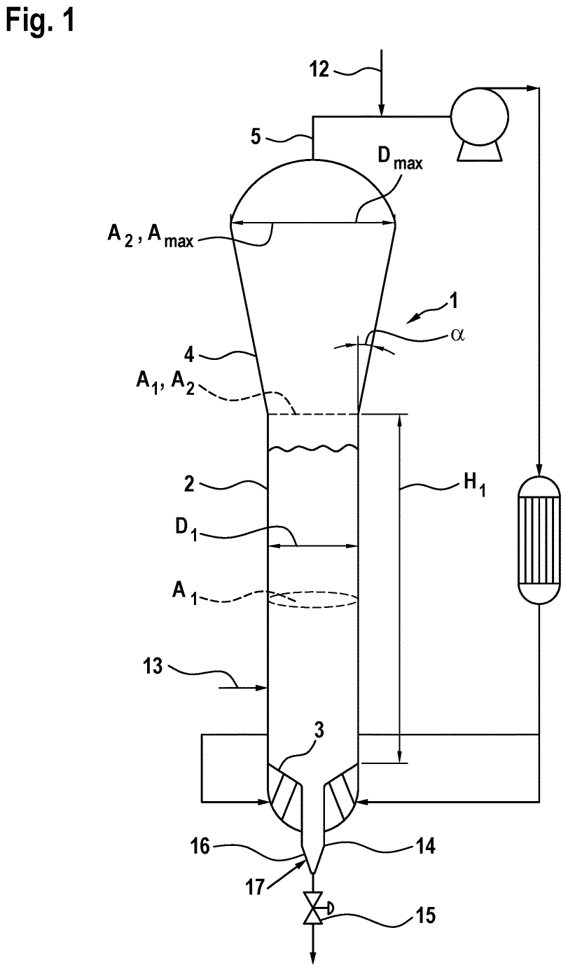

With respect to FIG. 1, a fluidized bed reactor 1 has an upright cylindrically shaped first section 2, a gas distribution grid 3 mounted in a lower part of the first section 2, and a frustrum shaped second section 4, which is placed vertically above the first section 2 and tapering out in a direction away from the first section 2.

The first section is a fluidization zone, wherein a fluidized bed of polymer is formed by an upwardly flow of gas fed through the gas distribution grid 3. The first section 2 has a diameter D₁ and a height H₁, measured from the uppermost part of the distribution grid to the end of the first section. The height H₁ is between about 10 to 25 m. In some embodiments, the first section 2 is cylindrical and has a circular cross sectional area A₁. In some embodiments, the cross sectional area A₁ is constant over the entire height of the first section 2.

In some embodiments, the second section 4 has a circular cross sectional area A₂, wherein the cross sectional area of the second section gradually increases with increasing distance in the vertical direction from the first section, until a maximum horizontal cross sectional area Aₘₐₓ is reached. In some embodiments and at the interface between the first section and the second section, the horizontal cross sectional areas are identical. In some embodiments and for preventing particle accumulation on the sloped surface of the second section, the second section tapers out from the first section at angle a of from 5 to 15°, alternatively from 7 to 13°, alternatively from 9 to 11°. It is believed that the increase of cross sectional area A₂ with increasing height until Aₘₐₓ is reached results in reducing the superficial fluidization velocity and terminates entrainment of solid particles with the gas flow. In some embodiments, Aₘₐₓ is 2.95 to about 3.2 times, alternatively between 2.95 and 3.2 times, higher than A₁. In some embodiments, the Aₘₐₓ is from about 2.9 to about 3.2, alternatively between 2.9 to 3.2, times larger than A₁. In some embodiments, the Aₘₐₓ is from 2.95 to 3.15, alternatively between 2.95 and 3.15, times higher than A₁. In some embodiments, Aₘₐₓ is more than 2.9 times larger than A₁.

In some embodiments, the top of the second section 4 is closed off by a dome shaped third section. In some embodiments, the dome shaped third section is provided with a recycle line 5. In some embodiments, the gaseous stream of the reaction gas, leaving the top of the second section via the recycle line 5, is compressed by a compressor and transferred to a heat exchanger, wherein the recycle gas is cooled. In some embodiments and below the heat exchanger, the gas recycle line is split in two branches, which are horizontally connected with the fluidized bed reactor 1 at positions below the gas distribution grid 3. In some embodiments, the recycle gas is cooled to below the dew point of one or more of the recycle gas components in the heat exchanger, thereby allowing the reactor to operate with condensed material (that is, in the condensing mode). In some embodiments, the recycle gas is made from or containing unreacted monomers, inert condensable gases, and inert non-condensable gases. In some embodiments, the inert condensable gases are alkanes. In some embodiments, the inert non-condensable gas is nitrogen.

In some embodiments, make-up monomer, molecular weight regulators, and optional inert gases are fed into the reactor 1 at various positions. In some embodiments, the components are fed via line 12 upstream of the compressor. In some embodiments, catalyst is fed into the reactor 1 via line 13. In some embodiments, line 13 is placed in the lower part of the fluidized bed.

In some embodiments and as shown in FIG. 1, the gas distribution grid 3 has the shape of an inverted cone, wherein a settling pipe 14 is provided. In some embodiments, the settling pipe 14 has an upper opening integrated into the gas distribution grid 3. Thus, the gas distribution grid and the settling pipe 14 form a funnel, wherein the settling pipe extends out of the first section 2 at an end distal from the second section. In some embodiments, the settling pipe projects out of the first section 2. In some embodiments, the upper opening of the settling pipe 14 is located in a central position with respect to the gas distribution grid 3. In some embodiments, the settling pipe is arranged coaxially with the first section, the second section, or both. In some embodiments, the settling pipe taper inwards at the settling pipe's lower end. In some embodiments, a discharge valve 15 is provided downstream of the settling pipe 14, for withdrawing the packed bed of polyolefin particles which forms within the settling pipe. In some embodiments, the settling pipe 14 further has at least one inlet 16. In some embodiments, the inlet 16 is arranged such that a fluid that an upward stream of an introduced fluid is induced in the bed of polyolefin particles above the fluid introduction point. In some embodiments, the inlet is configured to introduce the fluid into the lower third of the settling pipe, alternatively at a position near the lower end of the settling pipe. In some embodiments, the fluid is introduced at more than one position into the settling pipe. In some embodiments, the settling pipe has more than one inlet. In some embodiments, the fluid is a gas, which is feed via feeding line 17.

During operation of the fluidized-bed reactor 1, the settling pipe 14 contains a bed of polyolefin particles which moves from top to bottom of the settling pipe. In some embodiments, the polyolefin particles enter the settling pipe 14 through the upper opening and the polyolefin particles are withdrawn through discharge valve 15, alternatively a segmental ball valve. In some embodiments, the polyolefin particles are withdrawn continuously.

In some embodiments, propane is fed via line 17 into the settling pipe. In some embodiments, propane is fed at a position near the lower end of the settling pipe in an amount that an upward stream of the propane is induced in the bed of polyolefin particles.

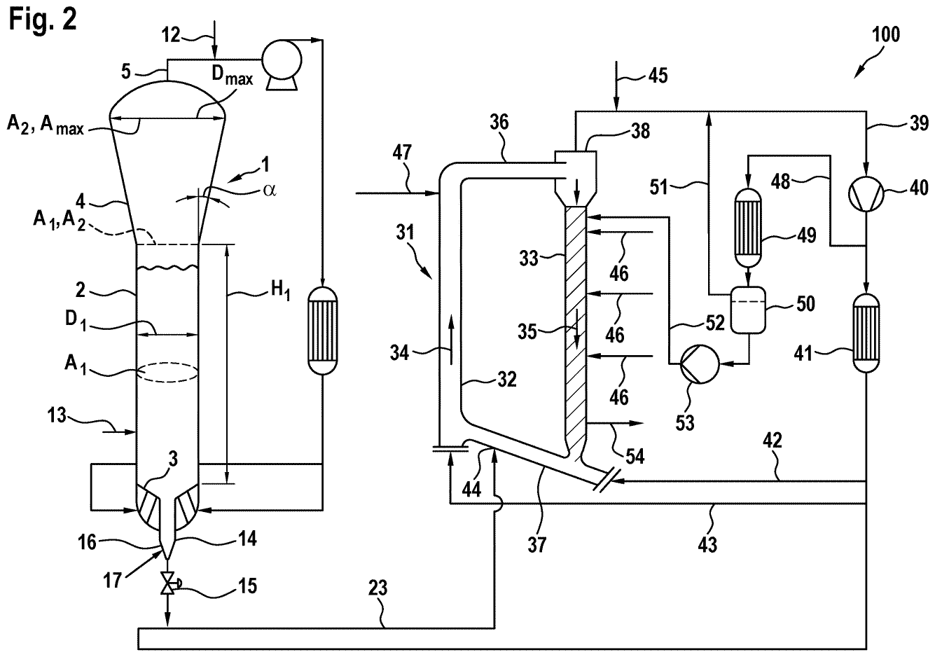

In some embodiments, the fluidized bed reactor is a standalone reactor or part of a reactor assembly having two or more reactors arranged in series. A reactor assembly 100 is shown in FIG. 2.

FIG. 2 shows a series of two reactors, including a fluidized bed reactor 1 and a multizone circulating reactor 31, wherein the multizone circulating reactor 31 is arranged downstream of the fluidized bed reactor. In some embodiments, the discharge valve 15 is arranged above a transfer line 23 for transferring the polyolefin particles to the multizone circulating reactor 31. The multizone circulating reactor 31 is a gas-phase reactor with two reaction zones, riser 32 and downcomer 33, which are repeatedly passed by the polyolefin particles.

Within riser 32, the polyethylene particles flow upward under fast fluidization conditions along the direction of arrow 34. Within downcomer 33, the polyolefin particles flow downward under the action of gravity along the direction of arrow 35. The riser 32 and the downcomer 33 are interconnected by interconnection bends 36 and 37.

After flowing through the riser 32, the polyethylene particles and the gaseous mixture leave the riser 32 and are conveyed to a solid/gas separation zone 38. In some embodiments, the solid/gas separation is effected by a centrifugal separator. In some instances, the centrifugal separator is a cyclone. From the separation zone 38, the polyolefin particles enter the downcomer 33.

The gaseous mixture leaving the separation zone 38 is recycled to the riser 32 by a recycle line 39, equipped with a compressor 40 and a heat exchanger 41. Downstream of the heat exchanger 41. the recycle line 39 splits. The gaseous mixture is divided into three separated streams: (i) line 42 conveys a part of the recycle gas into the interconnection bend 37; (ii) line 43 conveys another part the recycle gas to the bottom of the riser 32, thereby establishing fast fluidization conditions therein; and (iii) a further part of the recycle gas is conveyed through transfer line 23 for transferring the polyethylene particles obtained in fluidized-bed reactor 1 into multizone circulating gas-phase reactor 31. The polyethylene particles coming from the first gas-phase reactor via enter the multizone circulating gas-phase reactor 31 at the interconnection bend 37 in position 44.

In some embodiments, make-up monomers, make-up comonomers, and optionally inert gases or process additives are fed to the multizone circulating reactor 31 via one, two or more lines 45 or 46, placed at point(s) of the gas recycle line 39 or the downcomer 33. In some embodiments, process additives are fed via line 47. In some embodiments, the additives are antistatic agents.

A part of the gaseous mixture leaving the separation zone 38 exits recycle line 39 after the compressor 40 and is sent through line 48 to heat exchanger 49 where the part is cooled to a temperature at which the monomers and the optional inert gas are partially condensed. A separating vessel 50 is placed downstream the heat exchanger 49. The separated gaseous mixture is recirculated through line 51 to recycle line 39. The separated liquid is fed to the downcomer 33 through line 52 by pump 53.

In some embodiments, the polyethylene particles, obtained in the multizone circulating reactor 31, are continuously discharged from the bottom part of downcomer 33 via discharge line 54.

In some embodiments, the fluidized bed reactor and the multizone circulating reactor are operated simultaneously, such that the polyolefin particles are split between the first reactor and the second reactor. In some embodiments, the process is designed for a 50:50 split of the polyolefin throughput between the two reactors. In some embodiments, the fluidized bed reactors are designed to be at full capacity at that 50:50 split. In some embodiments, the fluidized bed reactor is oversized, such that the fluidized bed reactor has the capacity of running at a 100:0 split at the same throughput. In some embodiments, the reactor assembly is provided, wherein the fluidized bed reactor is used to prepare the total amount of the polyolefin. In some embodiments, the fluidized bed reactor produces a monomodal polyolefin at an hourly capacity, which is equal to the hourly capacity of the production of a bimodal or multimodal polyolefin in the series of reactors. By way of example, if the system has a capacity of 28.5 t/h in the first reactor and a capacity of 28.5 t/h in the second reactor when running the process at a 50:50 split, the fluidized bed reactor is configured to run at a 57.0 t/h capacity at a 100:0 split.

In some embodiments, the present disclosure further provides a process for preparing an olefin polymer. In some embodiments, the olefins are 1-olefins. In some embodiments, the olefins are nonpolar olefinic compounds. In some embodiments, the 1-olefins are linear C₂-C₁₂-1-alkenes, branched C₂-C₁₂-1-alkenes, conjugated dienes, or nonconjugated dienes. In some embodiments, the linear alkenes are linear C₂-C₁₀-1-alkenes. In some embodiments, the linear C₂-C₁₀-1-alkenes are selected from the group consisting of ethylene, propylene, 1-butene, 1-pentene, 1-hexene, 1-heptene, 1-octene, and 1-decene. In some embodiments, the branched alkenes are branched C₂-C₁₀-1-alkenes. In some embodiments, the branched C₂-C₁₀-1-alkene is 4-methyl-1-pentene. In some embodiments, the dienes are selected from the group consisting of 1,3-butadiene, 1,4-hexadiene or 1,7-octadiene. In some embodiments, mixtures of various 1-olefins are polymerized. In some embodiments, the olefins have the double bond as part of a cyclic structure. In some embodiments, the cyclic structure has one or more ring systems. In some embodiments, the olefins, including a cyclic structure, are selected from the group consisting of cyclopentene, norbornene, tetracyclododecene, methylnorbornene, 5-ethylidene-2-norbornene, norbornadiene, and ethylnorbornadiene. In some embodiments, mixtures of two or more olefins are polymerized. In some embodiments, the mixture is made from or containing two, three or four olefins.

In some embodiments, the olefin polymer is obtained by homopolymerizing an olefin or by copolymerizing an olefin and one or more other olefins. In some embodiments, the olefin polymer is obtained by homopolymerizing or copolymerizing ethylene or propylene, alternatively by homopolymerizing or copolymerizing ethylene. In some embodiments, comonomers in propylene polymerization are up to 60 wt. %, alternatively from 0.5 wt. % to 35 wt. %, of ethylene, 1-butene, 1-hexene, or a combination thereof. In some embodiments, comonomers in ethylene polymerization are up to 20 wt. %, alternatively from 0.01 wt. % to 15 wt. %, alternatively from 0.05 wt. % to 12 wt. %, of C₃-C₈-1-alkenes. In some embodiments, the alkenes are selected from the group consisting of 1-butene, 1-pentene, 1-hexene, 1-octene, and combinations thereof. In some embodiments, ethylene is copolymerized with from 0.1 wt. % to 12 wt. % of 1-hexene, 1-butene, or both.

In some embodiments, the homopolymerization of an olefin or the copolymerization an olefin and one or more other olefins is carried out at temperatures in the range from 20° C. to 200° C., alternatively from 30° C. to 150° C., alternatively from 40° C. to 130° C., and pressures from 0.1 MPa to 20 MPa, alternatively from 0.3 MPa to 5 MPa, in the presence of a solid particulate polymerization catalyst and an organometallic compound, which are fed with the olefin or the combination of an olefin and one or more other olefins, into a polymerization apparatus having a polymerization reactor or a combination of polymerization reactors.

In some embodiments, the polymerization catalyst is a solid particulate polymerization catalyst. In some embodiments, the solid particulate polymerization catalyst is in combination with an organometallic compound as cocatalyst. In some embodiments, the polymerization is carried out using Phillips catalysts based on chromium oxide, using Ziegler- or Ziegler-Natta-catalysts, or using single-site catalysts. As used herein, the term “single-site catalysts” refers to catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Ziegler or Ziegler-Natta type. In some embodiments, the catalysts of the Ziegler or Ziegler-Natta type are made from or containing a compound of titanium or vanadium, a compound of magnesium and optionally an electron donor compound, or a particulate inorganic oxide as a support material. In some embodiments, the titanium compounds are made of the halides or alkoxides of trivalent or tetravalent titanium. In some embodiments, the titanium compounds are titanium alkoxy halogen compounds or mixtures of various titanium compounds. In some embodiments, the halogen is chlorine. In some embodiments, at least one compound of magnesium is additionally used in the production of the solid component. In some embodiments, the magnesium compounds are halogenated magnesium compounds, alternatively magnesium halides. In some embodiments, the halides are chlorides or bromides. In some embodiments, the magnesium halides are obtained by reaction with halogenating agents. In some embodiments, the magnesium compounds are selected from the group consisting of magnesium dichloride, magnesium dibromide, and di(C₁-C₁₀-alkyl)magnesium compounds. In some embodiments, the magnesium compounds are di(C₁-C₁₀-alkyl)magnesium compounds. In some embodiments, electron donor compounds for preparing Ziegler or Ziegler-Natta type catalysts are selected from the group consisting of alcohols, glycols, esters, ketones, amines, amides, nitriles, alkoxysilanes and aliphatic ethers. In some embodiments, these electron donor compounds are alone or in mixtures. In some embodiments, these electron donor compounds are used with additional electron donor compounds. In some embodiments, the electron donor compounds are selected from the group consisting of amides, esters, and alkoxysilanes.

In some embodiments, the catalysts are Phillips-type chromium catalysts. In some embodiments, the catalysts of the Phillips type are prepared by applying a chromium compound to an inorganic support and subsequently activating the resulting catalyst precursor at temperatures in the range from 350 to 1000° C., thereby converting chromium from valences lower than six into the hexavalent state. In some embodiments, further elements are selected from the group consisting of magnesium, calcium, boron, aluminum, phosphorus, titanium, vanadium, zirconium and zinc. In some embodiments, the further elements are selected from the group consisting of titanium, zirconium and zinc. In some embodiments, combinations of the elements are used. In some embodiments, the catalyst precursor is doped with fluoride prior to or during activation. In some embodiments, supports for Phillips-type catalysts are made from or containing aluminum oxide, silicon dioxide, titanium dioxide, zirconium dioxide, mixed oxides or cogels, and aluminum phosphate. In some embodiments, the silicon dioxide is in the form of silica gel. In some embodiments, the support materials are obtained by modifying the pore surface area. In some embodiments, the pore surface area is modified by compounds of the elements boron, aluminum, silicon or phosphorus. In some embodiments, the support material is a silica gel. In some embodiments, the silica gels are spherical or granular silica gels. In some embodiments, the spherical silica gels are spray dried. In some embodiments, the activated chromium catalysts are subsequently prepolymerized or prereduced. In some embodiments, the prereduction is carried out by cobalt or hydrogen at 250° C. to 500° C., alternatively at 300° C. to 400° C., in an activator.

In some embodiments, the catalysts are supported single-site catalysts. In some embodiments, the single-site catalysts are made from or containing bulky sigma- or pi-bonded organic ligands, for examples, catalysts based on mono-Cp complexes, catalysts based on bis-Cp complexes, or catalysts based on late transition metal complexes. In some embodiments, catalysts based on bis-Cp complexes are designated as metallocene catalysts. In some embodiments, catalysts based on late transition metal complexes have the complexes as iron-bisimine complexes. In some embodiments, the catalysts are mixtures of two or more single-site catalysts or mixtures of different types of catalysts made from or containing at least one single-site catalyst. In some embodiments, the materials used as support for the Phillips-type chromium catalyst are used as support for the single-site catalysts.

In some embodiments, the solid particulate polymerization catalysts are used in combination with an organometallic compound. In some embodiments, the organometallic compounds are organometallic compounds of metals of Groups 1, 2, 12, 13 or 14 of the Periodic Table of Elements, alternatively organometallic compounds of metals of Group 13, alternatively organoaluminum compounds. In some embodiments, the organometallic compounds are organometallic alkyls, organometallic alkoxides, or organometallic halides.

In some embodiments, the organometallic compounds are cocatalysts for the solid particulate polymerization catalysts. In some instances, the organometallic compounds are scavengers which react with polar compounds. In some instances, the organometallic compounds act as catalyst poisons.

In some embodiments, the organometallic compounds are selected from the group consisting of lithium alkyls, magnesium alkyls, zinc alkyls, magnesium alkyl halides, aluminum alkyls, silicon alkyls, silicon alkoxides, and silicon alkyl halides. In some embodiments, the organometallic compounds are aluminum alkyls or magnesium alkyls. In some embodiments, the organometallic compounds are aluminum alkyls, alternatively trialkylaluminum compounds or compounds of this type in which an alkyl group is replaced by a halogen atom. In some embodiments, the halogen is chlorine or bromine. In some embodiments, the aluminum alkyls are selected from the group consisting of trimethylaluminum, triethylaluminum, tri-isobutylaluminum, and tri-n-hexylaluminum. In some embodiments, the halogenated aluminum alkyl is diethylaluminum chloride.

In some embodiments, the polymerization process is carried out as gas-phase polymerization (that is, a process wherein the solid polymers are obtained from a gas-phase of the monomer or the comonomers). In some embodiments, the gas-phase polymerizations are carried out at pressures of from 0.1 MPa to 20 MPa, alternatively from 0.5 MPa to 10 MPa, alternatively from 1.0 MPa to 5.0 MPa. In some embodiments, the polymerization temperatures are from 40° C. to 150° C. alternatively from 65° C. to 125° C.

In some embodiments, the gas-phase polymerization processes are carried out in the presence of a C₃-C₅ alkane as polymerization diluent, alternatively in the presence of propane. In some embodiments, the gas-phase homopolymerization or copolymerization of ethylene is carried out in the presence of a C₃-C₅ alkane as polymerization diluent, alternatively in the presence of propane.

In some embodiments and to reduce the amount of fine particles being entrained into the recycle line, the superficial gas velocity in the second section, alternatively at the maximum cross section Aₘₐₓ, is lower than 0.30 m/s, alternatively lower than 0.25 m/s, and higher than 0.05 m/s, alternatively higher than 0.1 m/s. In some embodiments, the superficial gas velocity in the first section (that is, the fluidization velocity) is lower than 0.75 m/s, alternatively lower than 0.60 m/s, and higher than 0.30 m/s, alternatively higher than 0.40 m/s.

In some embodiments, different or else identical polymerization reactors are connected in series, thereby forming a polymerization cascade. In some embodiments, the present disclosure provides a parallel arrangement of reactors using two or more different or identical polymerization methods.

In some embodiments, the process for preparing an olefin polymer is carried out in a series of two or more gas-phase reactors. In some embodiment, the polymerization of olefins is carried out in a series including a fluidized-bed reactor and a multizone circulating reactor. In some embodiments, the fluidized-bed reactor is arranged upstream of the multizone circulating reactor. In some embodiments, the series of gas-phase reactors includes additional polymerization reactors. In some embodiments, the additional reactors are low-pressure polymerization reactors such as gas-phase reactors or suspension reactors. In some embodiments, the series includes a pre-polymerization stage.

In some embodiments, the reactor cascade has a fluidized bed reactor as provided in the present disclosure and a second gas phase reactor arranged downstream of the fluidized bed reactor. In some embodiments, the second gas phase reactor is a multizone circulating reactor. In some embodiments, the reactor cascade is for preparing the polyolefin, alternatively polyethylene, in (a) both reactors or (b) the fluidized bed reactor and not the second gas phase reactor. In some embodiments, the reactor cascade is operated such that the fluidized bed reactor is used for preparing the polyolefin while the second gas phase reactor is not used for preparing the polyolefin. In some embodiments, the fluidized bed reactor has a diameter of more than 4.6 meters at the fluidization zone.

In some embodiments, the process prepares a polyolefin composition. In some embodiments, the polyolefin composition is a polyethylene composition. In some embodiments, the polyethylene composition has a density in the range of from 0.915 g/cm³ to 0.970 g/cm³. In some embodiments, the process prepares a monomodal high density polyethylene composition in the fluidized bed reactor, having a density of 0.945 to 0.970 g/cm³. In some embodiments, the process prepares a bimodal or multimodal high density polyethylene composition in a series of reactors. In some embodiments, the polyethylene composition has a density of 0.940 to 0.960 g/cm³, wherein the polyethylene produced in the first reactor of the series of reactors has a density higher than 0.950 g/cm³. In some embodiments, the process prepares a monomodal linear low density polyethylene composition, having a density of 0.915 g/cm³ to 0.930 g/cm³. In some embodiments, the process prepares a monomodal medium density polyethylene composition, having a density of 0.930 g/cm³ to 0.940 g/cm³.

### EXAMPLES

Using a series of a fluidized-bed reactor and a multizone circulating reactor (MZCR), having two interconnected reaction zones, a number of grades of a multimodal ethylene polymer were produced with an average output of 57 t/h with a 50/50 split at temperatures in the range from 60° C. to 110° C. and pressures from 1 MPa to 10 MPa.

The catalyst system for carrying out the polymerizations was a Ziegler-Natta catalyst system made from or containing a catalyst solid prepared by supporting TiCl₄ on a MgCl₂ carrier. The catalyst was fed to the fluidized-bed reactor at a rate in the range of from 4.0 to 6.0 kg/h. Triisobutylaluminum and diethylaluminumchlorine were employed as cocatalysts and fed to the polymerizations at feeding total rates in the range from 20 kg/h to 30 kg/h. In the examples, the fluidized-bed reactor was operated without the multizone circulating reactor for producing monomodal polyethylene grades, having a density in the range of from 0.9600 g/cm³ to 0.9670 g/cm³, determined according to ISO 1183-1:2012 at 23° C., and a MIE of about 7.5 to 8.5, where MIE is the melt flow index at 190° C. based on 2.16 kg load determined according to ISO 1133-2:2011.

Comparative Examples A and B were prepared using a reactor representative of a commercial reactor. For Comparative Example A, Comparative Example B, and Example 1, the same fluidizing gas was used. The fluidized bed reactors were designed for producing bimodal or multimodal grades in a reactor cascade. The fluidized bed reactor in the cascade had a throughput of 28.5 t/h. The catalyst had an average residence time of 3.15 h in the fluidized bed reactor. The fluidization velocity was about 0.75 m/s. The fluidization velocity was determined by a compressor, having a capacity of 44900 m³/h.

### Comparative Example A

In Comparative Example A, the fluidized bed reactor had a diameter, D₁, of 4.6 m in the cylindrical first section, and a maximum diameter of the second section, Dmax, of 7.3 m (area ratio Aₘₐₓ/A₁=2.52). The height of the first section, H₁, was 20 m.

Subsequently, the fluidized bed reactor was operated to produce a monomodal high density polyethylene with a catalyst residence time of 2 h and a fluidization velocity of about 0.75 m/s. The resulting max production was 44.9 t/h. Excessive carry over occurred, which resulted in shutdowns due to plugging of the heat exchanger, the distribution grid, or both.

### Comparative Example B

In Comparative Example B, the second section was adapted such that Dmax was increased to 8.9 m, while the diameter D₁ was maintained at 4.6, resulting in an area ratio Aₘₐₓ/A₁ of about 3.74. The cylindrical first section was not modified. The fluidized bed reactor was operated with the same compressor capacity as with Comparative Example A and a catalyst residence time of about 2 h.

The first section was modified. The resulting maximum throughput was 44.9 t/h even though the total volume of the reactor was increased. The increased diameter of the second section resulted in less entrainment of particles, thereby reducing the likelihood of plugging the heat exchanger, the distribution grid, or both. However, a larger amount of fines, accumulating on the sloped surface of the second section, was noticed, which was attributed to the second section widening at an angle close to the horizontal (that is, more than 15°).

### Example 1

In Example 1, both the first section and the second section were modified. The diameter D₁ was increased to 5.2 m while maintaining the same height H₁. The compressor capacity was maintained, thereby lowering the fluidization velocity. The second section was configured such that the ratio Aₘₐₓ/A₁ was about 2.98 while the angle a was about 10°. The superficial gas velocity, measured in the second section, was lower than 0.25 m/s. The fines circulation was comparatively lower while the average particle size of the fines collected from the recycle line was lower than 180 mm. Furthermore, fines accumulation on the sloped surfaces was mitigated.

The total volume of the reactor increased compared to Comparative Example A. In contrast to Comparative Example B, it is believed that the increase of volume was mainly attributed to the first section. When operating the process at a residence time of 2 h, the maximum throughput was increased to 57 t/h.

1. A fluidized bed reactor for gas phase fluidized bed polymerization of olefins, comprising:
(I)—a first section, which is an upright cylindrical section having a diameter D₁, a height H₁ and a cross sectional area A₁; and
(II)—a frustrum shaped second section, provided vertically above the first section and centered about a common vertical axis to the upright cylindrical first section,
(A) having a base with a cylindrical cross section of diameter D₁ joined to the top of the first section, and
(B) tapering out above its base at an angle a,
wherein
i) the second section has a maximum horizontal cross-sectional area A₂, which is between 2.95 to 3.2 times the cross sectional area A₁ of the first section;
ii) the height H₁ is between 10 to 25 m;
iii) the angle a is between 5 to 15°; and
iv) the diameter D₁ is more than 4.6 m.

2. The fluidized bed reactor of claim 1, wherein the fluidized bed reactor comprises a gas distribution grid and a settling pipe, wherein the settling pipe having an upper opening integrated into the distribution grid, the gas distribution grid being arranged in the first section and the settling pipe extending out of the first section at the end distal to the second section.

3. The fluidized bed reactor of claim 2, wherein the settling pipe has a tapered end distal to the gas distribution grid.

4. The fluidized bed reactor of claim 2, wherein the settling pipe is arranged coaxially to the first section.

5. A reactor assembly comprising a series of at least two gas-phase polymerization reactors, wherein at least one of the gas-phase polymerization reactors is a fluidized bed reactor according to claim 1.

6. The reactor assembly of claim 5, wherein the reactor assembly comprises two gas-phase polymerization reactors, wherein a first gas-phase polymerization reactor is a fluidized bed reactor according to claim 1 and a second gas-phase polymerization reactor is a multizone circulating reactor and arranged downstream of the fluidized bed reactor.

7. A process for preparing a polyolefin polymer from one or more olefins by gas-phase polymerization at temperatures of from 40 to 150° C. and pressures of from 0.1 to 20 MPa, in presence of a polymerization catalyst, wherein the polymerization is at least partly carried out in a fluidized bed reactor according to claim 1.

8. The process of claim 7, wherein gas velocity in the second section is lower than 0.30 m/s.

9. The process of claim 7, wherein the fluidization velocity is lower than 0.75 m/s.

10. The process of claim 7, wherein the polyolefin polymer is a polyethylene prepared by homopolymerizing ethylene or copolymerizing ethylene and C₃-C₈-1-alkenes.

11. The process of claim 10, wherein the polyethylene has a density in the range of from 0.915 g/cm³ to 0.970 g/cm³.

12. The process claim 7, wherein the reactor assembly comprises a series of at least two gas phase polymerization reactors, one of the gas phase polymerization reactors being the fluidized bed reactor according to claim 1, the polyolefin is prepared in the fluidized bed reactor, and the polyolefin is not prepared in any of the additional polymerization reactors.

13. The process of claim 12, wherein the reactor assembly comprises two gas phase polymerization reactors arranged in series, wherein the first gas-phase polymerization reactor being the fluidized bed reactor and the second gas-phase polymerization reactor being a multizone circulating reactor.

14. The process of claim 13, wherein the first gas-phase polymerization reactor is arranged upstream from the second gas-phase polymerization reactor.
